(19) United States
(12) Patent Application Publication
(10) Pub. No.: US 2025/0109455 A1
(43) Pub. Date: Apr. 3, 2025

(54) METHOD FOR THE SELECTIVE RECOVERY OF GOLD, PLATINUM, AND PALLADIUM USING DUAL ORGANIC SOLVENT EXTRACTION.

(71) Applicant: Benjamin Turner Suslavich, Ennis, MT (US)

(72) Inventor: Benjamin Turner Suslavich, Ennis, MT (US)

(21) Appl. No.: 18/479,035

(22) Filed: Sep. 30, 2023

(51) Int. Cl. C22B 11/00; C22B 3/36

(52) U.S. Cl. CPC C22B 11/04; C22B 3/362

(57) ABSTRACT

A molecule enabling the selective recovery of gold, platinum, and palladium from an oxidative organic solution that also contains contaminants such as base metals, polymers, or other gangue material. The disclosed formula simultaneously eliminates multiple costly and hazardous steps of recovering such metals by using a single chemical comminution and solvent extraction process using dual organic phases. The resulting gold, platinum, and/or palladium-containing solution can be stripped to recover these elements and to regenerate the extractant for subsequent use.

### 1. TECHNICAL FIELD

This invention relates to a novel extractant material and a method that can be employed in a solvent extraction system for the recovery of gold, platinum, and/or palladium from ores or scrap that contain base metals or other impurities.

### 2. PRIOR ART

### Background of Invention

The rapid advancement of technology in the modern era has led to an exponential increase in the demand for precious metals like gold, silver, platinum, and various rare earth elements. These materials serve critical roles in electronics, aerospace, medicine, and other cutting-edge industries. For years, mining high-grade ores was the primary method for sourcing these essential commodities, enabling industries to continue their robust growth. However, as the demand surges, we are confronted with an inconvenient reality: the depletion of high-grade ore reserves. Natural terrestrial sources are not only becoming increasingly scarce but also are often found in geographically challenging or politically unstable regions. This scarcity poses not just an economic problem, but an ecological one, as the extraction processes for lower-grade ores require more energy and result in higher levels of environmental degradation.

Given this complex backdrop, the method and reagent described herein are significant. It outlines a method for the efficient recovery of precious metals from diverse sources, including electronic waste and extraterrestrial ores.

One major obstacle to achieving efficient and sustainable extraction is the reagent used in the extraction process. U.S. Pat. No. 7,291,202 describes the extraction of gold using di-n-hexyl sulfide as an extractant and using a hydrochloric acid solution as a leach liquor. However, the method requires multiple steps for extraction and scrubbing to extract other metals, such as palladium.

An ideal process would allow for the initial extraction of all target precious metals during the first extraction while rejecting any non-target base metals.

Similarly, U.S. Pat. No. 4,390,366 describes a process to separate gold and platinum group metals from aqueous solutions using dibutyl carbitol to remove gold, and then alkyl sulphide and tributyl phosphate to remove palladium and platinum respectively.

Again, a more ideal process would allow for the extraction of all target precious in a single pass instead of requiring at least three separate extractions. In addition, using aqueous solutions to oxidize the precious metals inevitably will result in the oxidation of base metals associated with the target metal. In some natural and man-made ores such as electronic waste, the amount of unwanted base metals far exceeds the quantity of target precious metals. This results in a highly inefficient process. Significant quantities of reagent are consumed in the dissolution of unwanted metals. Furthermore, these metals can compete with target precious metals in the extractant.

Wei Lin et al. have shown that organic solutions of thionyl chloride dissolved in an organic solvent such as pyridine. N,N-dimethylformamide, or imidazole are capable of selective dissolution of platinum group metals. (Chem. Int. Ed. 2010, 49, 7929-7932). Furthermore, Gill, Goodall, and Jefferys showed that non-aqueous systems such as dimethyl sulphoxide and sulfur dioxide can dissolve metal oxides by forming metal disulphates. (B. Hydrometallurgy, 1984, 13, 221-226).

In addition, non-aqueous solutions have the added benefit of being able to be tailored to interact with the underlying material. This interaction can cause swelling, delamination, or structural failure of the material. This reduces the particle size and increases the surface area exposed to the organic phase. Processes such as this are referred to as “chemical comminution.”

However, to use any of these methods in conjunction with solvent extraction would require the removal of the organic either through vacuum stripping or through the distillation of the solution. This is because the powerful solvents used in the process are miscible with both water and most organic solvents. Solvent extraction requires the immiscibility of the solvent and feed solution to achieve a partition of the target metals. The present invention overcomes this problem allowing for the simultaneous use of organic raffinate along with an organic extractant that can remove target platinum group metals in a single step.

### SUMMARY OF THE INVENTION

The noted shortcomings of typical processing methods are solved in the disclosed method and system herein. The disclosed methods facilitate the selective extraction and concentration of precious metals with minimum addition of reagents. The method consists of four processes. The first consists of the dissolution of precious and base metals into solution in an organic phase. The second consists of the selective solvent extraction in a fluorinated phase. The third process consists of a stripping phase. The fourth consists of a regeneration phase to refresh the oxidant in the dissolution phase.

As this disclosure shows, the improvement to the existing process is the simultaneous use of two organic phases (one of which is fluorinated) to both selectively oxidize and extract precious metals from any solids added to the reactor. This is possible in part due to the use of a novel complexing agent, which is highly selective for platinum group metals. This complexing agent is capable of removing greater than 95% of dissolved precious metals into the fluorinated phase. In addition, the complexing agent is capable of extracting multiple species of platinum group metals while ignoring transition metals such as iron, nickel, and copper, as well as organic molecules in solution.

Thanks to this high selectivity, there can be significant reagent savings to facilitate processing.

With respect to the descriptions disclosed herein, it is to be understood that the invention and method described are not limited in their application to the details of construction and to the arrangement of the components in this specification or illustrated in the drawings showing the metal extraction method herein.

It is to be understood that the phraseology and terminology employed herein are for the purpose of description and should not be regarded as limiting.

### BRIEF DESCRIPTION OF THE DRAWINGS

As disclosed throughout this specification, FIG. 1 shows an example of the extracting agent that works by forming a complex with gold, platinum, and palladium that is stronger than the bonds formed between the respective metals and chloride ions, whereas FIG. 2 shows a generic embodiment of the molecule.

FIG. 3 shows the change in concentration of the platinum group species as well as that of nickel, copper, and iron. The concentrations of nickel, copper, and iron are divided by a factor of ten.

FIG. 4 shows the change in concentration of the platinum group species as a function of time of the raffinate solution undergoing the process described in Example 1.

### DETAILED DESCRIPTION OF PREFERRED EMBODIMENTS OF THE INVENTION

As disclosed herein, the novel extraction component described herein allows for the recovery of gold, platinum, and palladium selectively from an oxidative organic medium into a fluorinated organic medium while leaving base metal or other extracted contaminates in the organic layer. The disclosed extractant contained in the fluorinated phase can then be scrubbed to remove extracted metals for further processing. However, while this will allow for the recycling of extracting agents, it is not required.

The extracting agent (an example of which is shown in FIG. 1) appears to work by forming a complex with gold, platinum, and palladium that is stronger than the bonds formed between the respective metals and chloride ions. The extracting agent also selectively dissolves in the fluorinated phase as opposed to the organic phase. This allows organic solvents to be used to leach the metals as opposed the an aqueous solution. While aqueous leaching solutions could be used as well, organic solutions allow for chemical comminution or chemical delamination of the respective material being leached.

Chemical comminution is the process by which target metals, such as platinum group metals, are liberated from their matrix material. Typically, this process is performed mechanically either by grinding, breaking, cracking, fracturing, burning, dissolving, oxidizing, or otherwise compromising the gangue material allowing for direct access to the target metal by the leaching solution. The trouble with this method is that when the target metal is either finally divided or distributed amongst the matrix material, or the matrix material undergoes plastic deformation/failure rather than brittle failure, or is otherwise hazardous or expensive to treat, traditional methods are inadequate. For instance, grinding a mineral to the particle size necessary to fully liberate highly dispersed gold from its matrix can require grinding to micron-sized particles. As particles become smaller, it requires exponentially more energy to reduce their size through mechanical means. This is problematic for any operation where minimization of energy consumption is a critical design factor.

Chemical comminution breaks materials apart using the inherent electrostatic attraction between molecules to induce swelling in the base material. Certain materials, such as polymers with low crosslinking, minerals held together with electrostatic force, or materials with inherent cracks are highly susceptible to chemical comminution. The mechanism of operation is that the active chemical swelling agent(s), which is usually a liquid but could be a gas, supercritical fluid, colloidal suspension, or any other form of matter other than a plasma or a solid is allowed to fully wet the material in question. A chemical species or mixture of species, known as a swelling agent or agents, is chosen that is capable of electrostatically interacting with the material in question to a greater extent than that material interacts with itself. As a result, the swelling agent begins to penetrate the structure of the matrix material.

If enough swelling agent is able to penetrate the matrix material to disrupt the electrostatic bonds between the matrix's structure, then swelling has occurred. With further agitation, the matrix material will break down into smaller fragments or delaminate. The process can be aided by heating liquid.

Chemical comminution is analogous to removing an adhesive sticker from a surface using a solvent. The adhesive attaches to the surface through electrostatic forces. When the solvent is introduced, the adhesive will lose its attraction to the surface resulting in easy removal.

The exact formulation of desirable reagents for the process of chemical combination is beyond the scope of this invention. However, the reagents are typically organic solvents. Polar aprotic solvents appear to be ideal for materials such as mica, talc, graphite, and selenite. Such processes can also be used for the liberation of man-made materials as well such as printed circuit boards where layers of glass and metal are bound together using various epoxies. Typically these epoxies are based on the bisphenol-A monomer. Certain swelling agents can cause complete separation of printed circuit board layers. In addition, certain wood and paper products such as cardboard, fiberboard, and plywood are prime candidates for chemical comminution. In industry, these materials are typically recycled using water and soaps as swelling agents.

In one embodiment of the present invention, ethanol (EtOH) was used as a solvent in conjunction with 33% aqueous H₂O₂, and a chemical excess of Cl₂ gas as an oxidant. In another embodiment, the Cl₂ gas was substituted with I₂ crystals at a concentration ranging from 0.001% to 0.010% by weight.

In another embodiment of the present invention. EtOH was replaced with tetrahydrofuran (THF) to great effect. However, other solvents that can be used include benzene, phenol, ethylene glycol, carbon tetrachloride, chloroform, ethyl acetate. DMSO, acetone, acetonitrile hexane, dimethylformamide, and N-methylformamide.

Once the material is liberated, extraction can occur. Precious metals such as platinum and palladium are characteristically resistant to oxidative attack. However, certain reagents are able to oxidize these materials. Gold is traditionally oxidized by a mixture of nitric and hydrochloric acid. However, these acids would not be compatible with many organic solvents or swelling agents. The oxidant needs to be carefully selected to prevent the degradation of the organic phase.

Iodine, in conjunction with peroxides, has been effective, but other oxidizing agents such as chlorine, perchlorates, permanganates, thionyl chloride, and the like can also be used, provided they are chemically compatible with the underlying organic. Great care should be taken with the selection of oxidants to prevent run-away or even explosive reactions with the organic solvent.

### Example 1

In one embodiment, artificial ore comprising of 0.1% Gold, 0.1% platinum, 0.1% palladium, 2% iron, 2% nickel, 2% copper, 20% graphite, and the remainder of feldspar was added to an EtOH solution, with I₂ at a concentration of 0.005% by weight of the solution. 33% aqueous H₂O₂ was added gradually into the solution to regenerate I⁻ ions back to I₂. Dissolution was carried out by stirring for 5 hours at room temperature in the EtOH—I₂ solution.

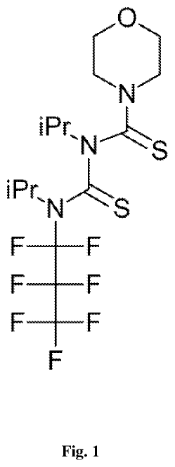

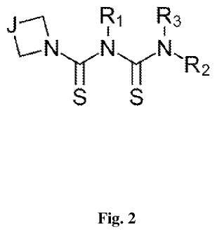

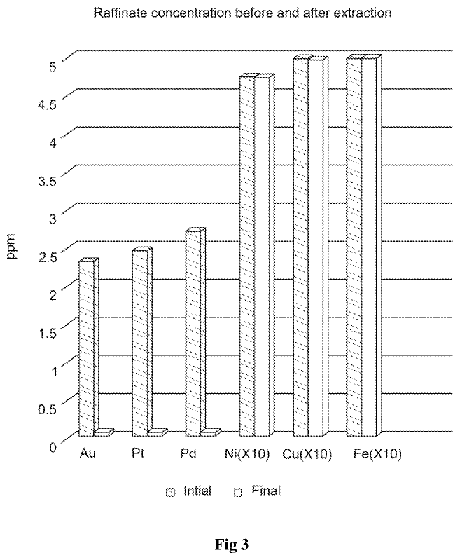

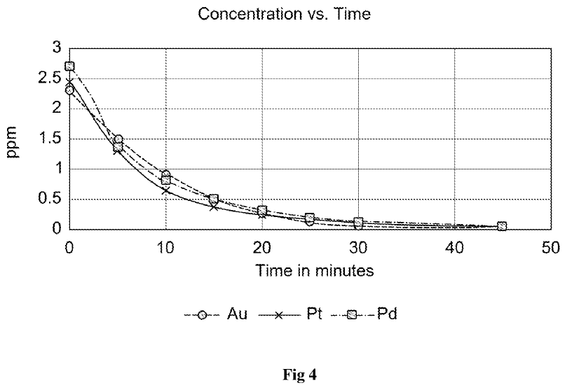

Once dissolution has occurred, a solution of n-flourohexane with 0.5% by weight of the extracting agent described herein was added to the EtOH—I₂ solution. The ratio by volume of the fluorinated extractant solution to EtOH—I₂ solution was approximately 1:1. Due to the immiscibility of the two solutions, an extraction was carried out in a separatory funnel. The solutions were mixed vigorously for 15 minutes and allowed to separate for 1 hour. While emulsions were not experienced, the addition of small quantities of water was able to aid the separation of the two phases. Small samples of the raffinate were drawn throughout the process in five-minute intervals for a total of 45 minutes. The change in concentration of the platinum group species is shown in FIG. 3 and FIG. 4. Note, in FIG. 3, that the concentrations of nickel, copper, and iron were divided by a factor of ten so that they could be displayed on the same graph.

The fluorinated phase was then separated and treated with an acidified thiourea solution of approximately 1M thiourea and 1M HCl. The solutions were vigorously stirred for 8 hours before being separated for reuse.

### Example 2

In one embodiment, printed circuit board chips were successfully leached using a combination of THF to expose gold contacts on the circuit board by removing the polymer film solder mask and permanganate combined with I₂ at a concentration of 0.005% by weight of solution. Permanganate was added gradually into the solution to regenerate I ions back to I₂. However, reagentless production could be achieved using electrolytic regeneration. Dissolution was carried out by stirring for five hours at room temperature in the THF—I₂ solution.

Once dissolution occurred, a solution of n-flourohexane with 0.5% by weight of the extracting agent described herein was added to the THF-I₂ solution. The ratio by volume of the fluorinated extractant solution to THF—I₂ solution was approximately 0.1:1. Due to the immiscibility of the two solutions, the extraction was carried out in a separatory funnel. The solutions were mixed vigorously for 15 minutes and allowed to separate for 1 hour. While emulsions were not experienced, the addition of small quantities of water was able to aid the separation of the two phases.

The fluorinated phases were then separated and treated with an acidified thiourea solution of approximately 1 M thiourea and 1 M HCl. The solutions were vigorously stirred for 8 hours before being separated for reuse. Precious metals could then be further reduced either electrolytically or through reducing agents such as sodium borohydride and the like.

### Example 3

To create the extractant, the following procedure was followed. To a mixture of 0.1 mols of morpholine amine and 0.1 N,N′-Diisopropylcarbodiimide dissolved in methanol, a stoichiometric excess of CS₂ was slowly added while keeping the reaction below 10° C. The precipitate was then removed and added to a solvent consisting of a 1:1 mixture of carbon tetrachloride and methoxyheptafluoropropane. The precipitate allowed it to stir but never fully dissolved. To the suspension, 0.1 mols of 1-Iodoperfluorobutane was slowly added with ultrasonication and refluxed overnight. After refluxing, the solution was washed with water, and the remaining carbon tetrachloride was stripped off under vacuum. The solution was filtered and returned to the vacuum to strip off the remaining solvent. The product was then recrystallized from methoxyheptafluoropropane and sent for chemical analysis. The structural formula for the extracting agent produced by the above method is given below:

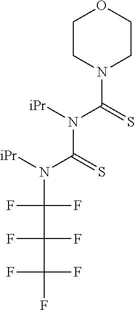 [SMILES: CC(C)N(C(=S)N1CCOCC1)C(=S)N(C(C)C)C(F)(F)C(F)(F)C(F)(F)F]

The above structure can easily be modified by substituting reagents. For instance, the isopropyl groups (iPr) can be substituted for cyclohexyl, cyclopentyl, ethyl, and methyl, or a combination thereof by substituting the appropriate carbodiimide. Furthermore, the perfluoro group can be substituted by substituting 1-iodoperfluorobutane for the appropriate reagent. Fluorinated carbon chains ranging from one to six carbon appear to be ideal. However, such fluorinated carbon chains can be attached by various hydrocarbon groups. Morpholine amine can also be substituted for another reagent as well, although only reagents with either a small dipole or were fluorinated proved to exhibit desirable solubility properties.

However, care must be taken to ensure the molecule contains enough partition value that it favors the fluorinated phase over the organic or aqueous phases. FIG. 2 shows a generic embodiment of the molecule.

The following derivative compounds were synthesized and tested:

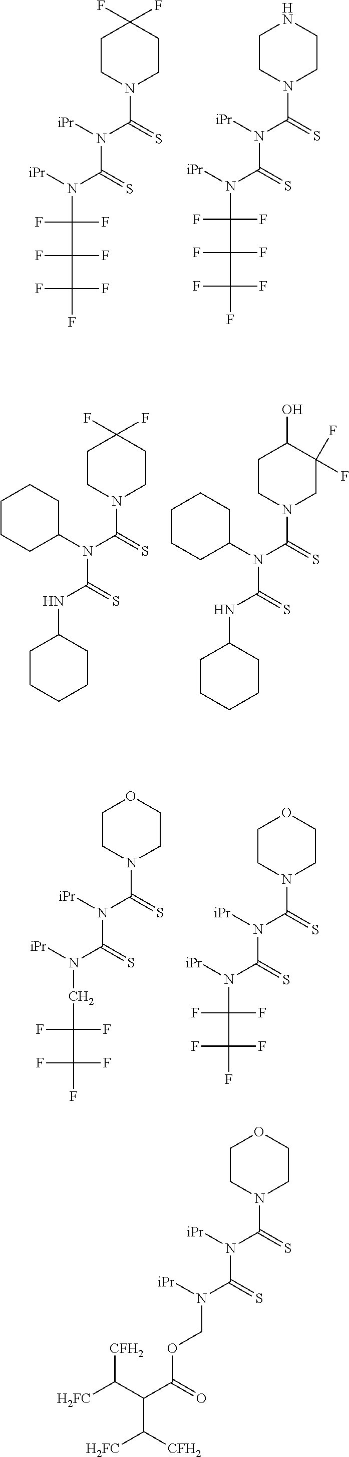

Amongst these derivative compounds, similar performance was achieved. However, the larger molecules suffered from decreased solubility in the fluorinated phase.

As for the diluent, the diluent is the solvent in which the extractant is dissolved. For phase separation to occur between the diluent and raffinate, the phases must be immiscible. While there is a near-infinite number of combinations of immiscible diluent and raffinate mixtures, the following is a non-exhaustive list of diluents that, either by themselves or in combination, could support the above extractant: n-flourohexane; n-flouroheptane; n-fluorooctane; n-flurononane; n-flurododecane; n-perfluroisohexane; 1-Methoxyheptafluoropropane; Tetradecafluoro-2-methylpentane; Pentadecafluorotriethylamine; perfluro-(2-butyletrahydrofuran); 1,1,1,2,2,3,4,5,5,5-decafluro-3-methoxy-4-(trifluromethyl)-pentane; (perfluro-n-octyl) ethylene, (perflurobutyl) ethylene; (perflurohexyl) ethlene, 1H-tridecaflurohexane; 1H-Undecafluoropentane; 2,2-diflouroethanol; 1,1,7-trihydroperfluroheptanol; 2,2,3,3,4,4,5,5,6,6,7,7-dodecafluro-1,8-octanediol; 1H-1H-11H-eicosafluro-1-undecanol; 2-(perfluro-n-octyl) ethanol; 1H,1H-perfluro-1-nonanol; 1,1,1,3,3,3-Hexafluro-2-methyl-2-propanol; 1H,1H-heptafluro-1-butanol; 1H,1H,10H,10H-Hexadecafluro-1-10-decanediol; 1H,1H,9H-hexadecafluro-1-nonanol; Perfluoropinacol; 2,2,3,4,4,4-Hexafluoro-1-butanol; 2,2,3,3,4,4-Hexafluoro-1-5-pentanediol; 1, 1,1,3,3,3-Hexafluoro-2-propanol: 1H,1H-Perfluoro-1-decanol; and Perfluoro-tert-butanol.

What is claimed is:

1. A method of separating at least one of gold, palladium, and platinum, from an oxidative organic solution containing either or both chloride or iodide complexes of at least one of said metals while employing the steps of an extractant that is a derivative compound represented by the following structure formula: 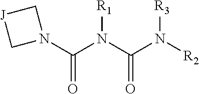
wherein J represents a group comprising: —CH₂—O—CH₂—, —CH₂—CF₂—CH₂—, —CF₂—CF₂—CF₂—, CF₂—CHOH—CH₂—, —CH₂—NH—CH₂—; R₁ is isopropyl, cyclohexyl, ethyl, or methyl; R₂ is isopropyl, cyclohexyl, ethyl, or methyl; R₃ is —CF₂—CF₃, —CH₂—CF₂—CF₃, —CF₂—CF₂—CF₃, —CF₂—CF₂—CF₂—CF₃, —CH₂—CH₂—CF₂—CF₃, —CH₂—CH—(CF₃)₂, —CH₂—CF—(CF₃)₂, —CH₂—C—(CF₃)₃, —CH₂—CH—(CF₂—CF₃)₂, —CH₂—CF—(CF₂—CF₃)₂, —CH₂—C—(CF₂—CF₃)₃, —CH₂OCO—CF₂—CF₃, —CHOCO—CH₂—CH—(CF₃)₂, —CHOCO—CH₂—CF—(CF₃)₂, —CH₂OCO—CH₂—C—(CF₃)₃, —CHOCO—CH₂—CH—(CH(—CFH₂)₂)₂, and is dissolved in a fluorinated or partially-fluorinated organic diluent which is immiscible with an organic raffinate solution.
